(19) United States
(12) Patent Application Publication
(10) Pub. No.: US 2012/0235324 A1
(43) Pub. Date: Sep. 20, 2012

(54) VEHICLE FLOORING SYSTEM

(75) Inventor: William E. Stimel, Alexandria, OH (US)

(73) Assignee: CVG MANAGEMENT CORPORATION, New Albany, OH (US)

(21) Appl. No.: 13/420,112

(22) Filed: Mar. 14, 2012

Related U.S. Application Data
(60) Provisional application No. 61/453,436, filed on Mar. 16, 2011.

(51) Int. Cl. B29C 41/08; B28B 13/02

(52) U.S. Cl. 264/309; 425/447

(57) ABSTRACT

A vehicle spray flooring system is provided that includes a single-sided mold component and a spray application component that facilitates application of a liquefied mixture into the single-sided mold. The application of the liquefied mixture results in a vehicle flooring product, whereby the liquefied mixture is a combination of urethane and polyurea.

### CROSS-REFERENCE TO RELATED APPLICATIONS

This application claims the benefit of U.S. Provisional Patent application Ser. No. 61/453,436 entitled “VEHICLE FLOORING SYSTEM” and filed on Mar. 16, 2011. The entireties of the above-noted applications are incorporated by reference herein.

### ORIGIN

The subject innovation relates generally to the field of vehicle interior flooring systems and more particularly, to systems and methods of manufacture and molding of vehicle interior flooring material and insulation systems.

### BACKGROUND

Today, many products are manufactured by way of molding. The process usually involves shaping pliable raw material using a rigid frame or model called a “pattern,” also oftentimes referred to as a “mold.” A “mold” often refers to a hollowed-out block that can be filled with a liquefied plastic, glass, metal, ceramic materials, or the like. In manufacturing, the liquid hardens or “sets” inside the mold, adopting the shape of the mold's inner surface. Once hardened, a release agent is typically used to effect removal of the hardened/set substance from the mold.

Injection molding is a manufacturing process for producing items from materials such as thermoplastic and thermosetting plastic materials. In most instances, the thermoplastic or thermosetting plastic material is inserted into a heated container, mixed, and forced (or injected) into a mold cavity often using a two-part mold. Thereafter, the material cools and hardens to the configuration of the mold cavity.

Molds are most often constructed from metal, usually either steel or aluminum, and precision-machined to form the features of the desired part. Injection molding is widely used for manufacturing a variety of parts, from the smallest component to entire vehicle body panels. Another form of molding is referred to as reaction injection molding or RIM. This type of molding is similar to injection molding however, thermosetting polymers are used in place of plastics. These thermosetting polymers require a curing reaction to occur within the two-part mold. Common vehicle components manufactured via RIM include bumpers, air spoilers, and fenders.

### SUMMARY

The following presents a simplified summary of the specification in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, discloses a vehicle flooring system that includes a single-sided mold component and a spray application component that facilitates application of a liquefied mixture into the single-sided mold, wherein the application results in a vehicle flooring product.

In another aspect, the innovation discloses that the liquefied mixture is a combination of urethane and polyurea.

In yet another aspect, the innovation discloses the use of a foil or other type of heat deflector that can be molded into the flooring system that deflects heat away from a vehicle's occupant compartment. In addition, other sound proofing materials can be molded-in as desired for noise-cancelling insulation.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a flooring manufacturing system for a vehicle in accordance with aspects of the innovation.

FIG. 2 illustrates an example flow chart of procedures that facilitate manufacturing a flooring product for a vehicle in accordance with aspects of the innovation.

FIG. 3 illustrates a top perspective view of an example single-sided mold in accordance with aspects of the innovation.

FIG. 4 illustrates an example flooring product manufactured in accordance with aspects of the innovation.

FIG. 5 is an illustration of a schematic block diagram of an exemplary computing system in accordance with the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

As described above, in a reaction injection molding (RIM) process, two parts of a polymer are mixed together and subsequently injected into a mold under high pressure, e.g., using an impinging mixer. The mixture is left in the mold for a period of time sufficient for the mixture to expand and for the curing reaction to complete.

Additionally, if desired, reinforcing agents can be added to the mixture prior to injection. This process is often referred to as reinforced reaction injection molding (RRIM). For example, reinforcing agents such as glass fibers can be added into the mixture so as to enhance strength of the final product. For this reason, it will be appreciated that RRIM is often used to produce rigid automotive panels. A subset of RRIM is structural reaction injection molding (SRIM), which uses fiber mesh as a reinforcing agent. In accordance with SRIM, the fiber mesh is first arranged in the mold and then the polymer mixture is injection molded onto the mesh.

Traditionally, flooring products (e.g., mats) for vehicles were manufactured using adhesives and glues to bond stock materials together. These materials were later die-cut or overlayed with an injected top surface. To the contrary, the innovation described herein, in aspects thereof, provides for a spray-applied top surface. In particular embodiments, the spray “skin” employs a mixture of urethane and polyurea. One particular aspect employs approximately 5% urethane and 95% polyurea in the spray mixture.

The novel manufacturing system (and method) of the innovation provides for clarity in the finished product aesthetics above that of conventional manufacturing techniques. In particular aspects, the innovation provides for in-molded features and components such as foils and logos as desired. For example, a desired logo or other treatment (e.g., grain type) can be provided on the A-side of the flooring product and foils can be molded onto (or into) the B-side of the flooring product. It will be appreciated that foils can be particularly useful in deflecting and insulating from heat, for example, generated from exhaust and engine components beneath the floor surface. While the molded-in features are described in combination with the novel spray application, it is to be understood that this specification is to include molded-in features such as foils and insulators in a more traditional molding process (e.g., injection molding).

Additionally, the innovation can provide for variable thickness in the flooring product. It will be appreciated that this variable thickness can enhance wear-ability as well as assist in audible and thermal reduction, e.g., from road noise and engine/exhaust components respectively.

In accordance with the innovation, a spray (e.g., mixture of urethane and polyurea) can be employed to manufacture a flooring product, such as but not limited to a floor mat. The innovation further employs a single-sided mold that has a draft angle of approximately 90 degrees to facilitate the removal of the finished flooring product. In other words, the method can be described using the perspective of zero degrees as a shear condition. In aspects, the single-sided mold includes a vertical wall ninety degrees to the main horizontal surface. In conventional injection processes, a male/female tool is used, which with zero degrees, generates shear upon the vertical portion. The innovation alleviates this effect by employing a spray application process. In other words, the spray process uses a single-sided tool for this application, which lends to greater flexibility in design and alleviates from shearing. Accordingly, endless three-dimensional capabilities are possible with this unique manufacturing system and method.

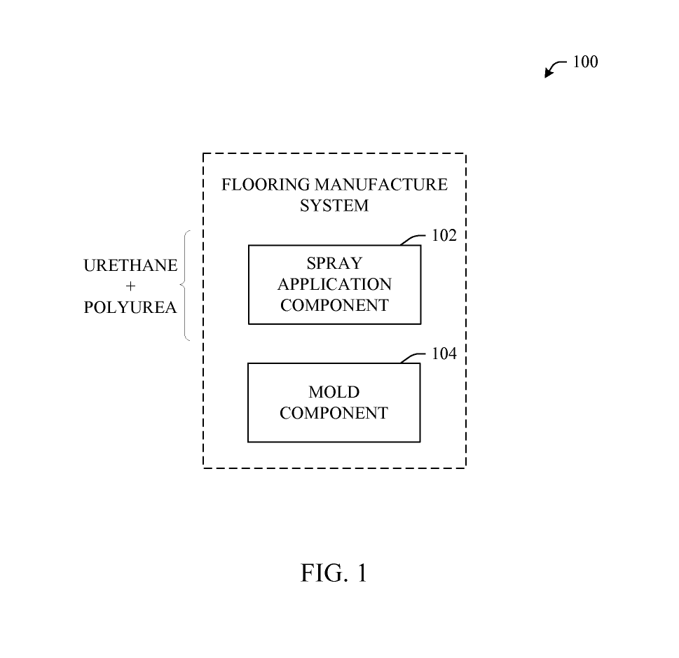

Referring to FIG. 1, a block diagram of a flooring manufacturing system 100 to manufacture a flooring product (e.g., a floor mat) is shown in accordance with aspects of the innovation. As shown, the system 100 can include a spray application component 102 and a mold component 104. The spray application component 102 can be used to apply a liquefied material into a cavity of a single-sided mold. For example, the spray application component 102, as shown, can be used to apply a liquefied spray mixture of urethane and polyurea. As mentioned above, one particular aspect employs approximately 5% urethane and 95% polyurea in the liquefied spray mixture.

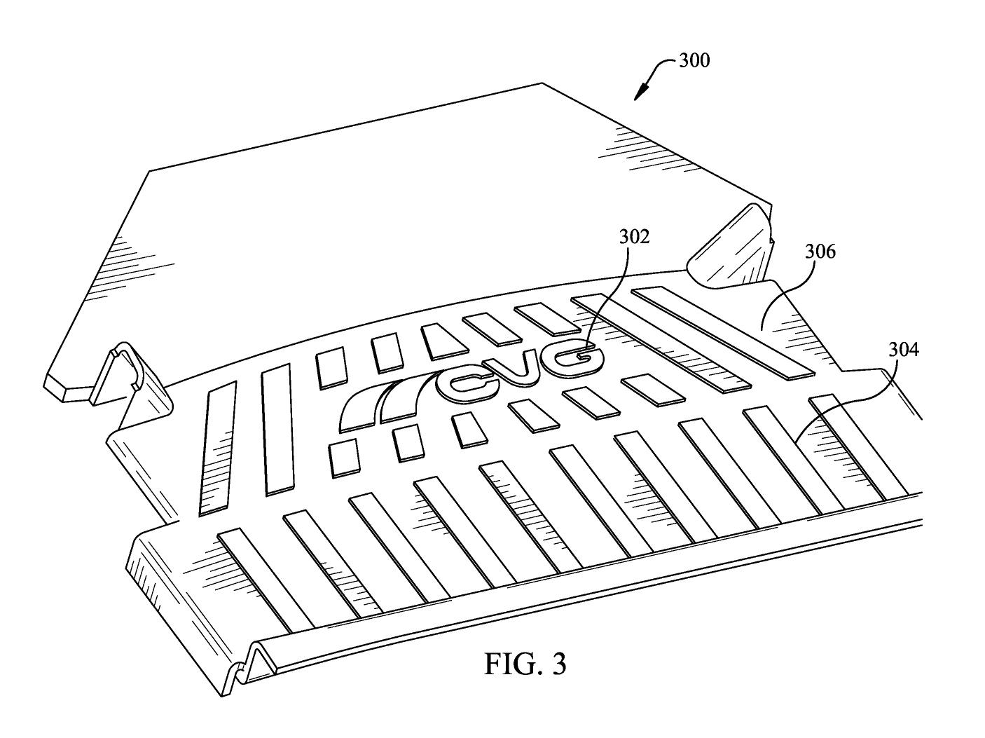

The mold component 104 can be comprised of a single-sided mold. In addition, the single-sided mold can include surface treatments that will be transferred to a top surface (A-side) of the flooring product to enhance aesthetics or functionality of the molded product. For example, a logo, ridges, a grain type structure, etc. can be applied to the top surface of the single-sided mold, described further below in reference to FIG. 3. In addition, foil(s) can be molded onto (or into) a B-side of the flooring product to serve to deflect heat from a passenger compartment from sources such as an exhaust.

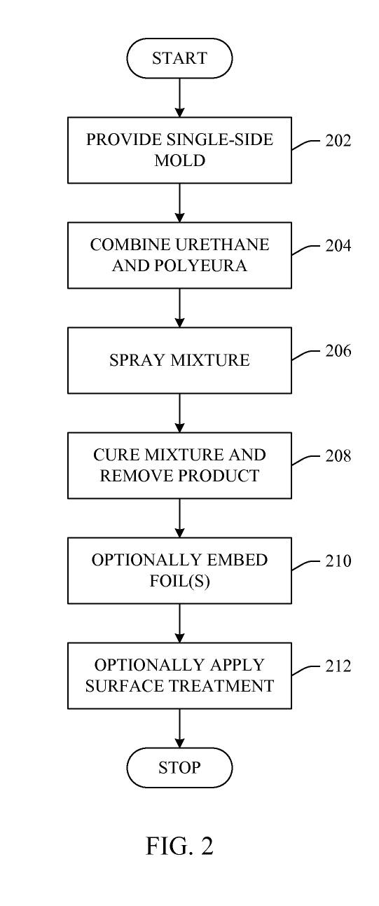

FIG. 2 illustrates a methodology of manufacturing a flooring product in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. Moreover, not all illustrated acts may be required to implement a methodology in accordance with the innovation.

At 202, a single-sided mold is provided. It is to be understood that because the novel flooring manufacturing system employs a spray component described above, a single-sided (or single-part) mold is all that is required to manufacture the flooring product. At 204, a spray mixture is prepared to apply to the single-sided mold. For example, a mixture of urethane (e.g., approximately 5%) and polyeura (e.g., approximately 95%) can be combined in preparation of spraying into the mold at 206. At 208, the spray mixture is cured for a predetermined period of time and removed from the single-sided mold.

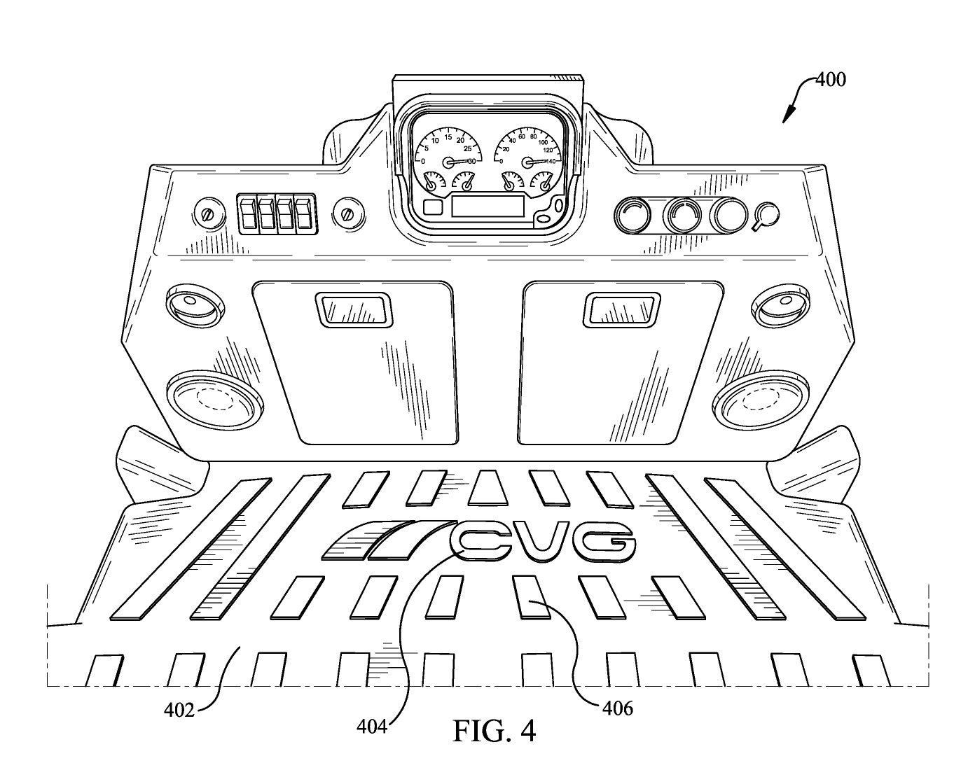

It will be understood that optional acts can take place at 210 and 212. For example, at 210, a foil(s) or other temperature deflector/insulator can be embedded into the flooring product. It will be understood that a molded-in foil can enhance occupant comfort by blocking or shielding heat from entering the vehicle, e.g., cab of a long haul truck. Additionally, at 212, a surface treatment (e.g., logo, pattern such as graining or logo) can be applied so as to enhance aesthetics as well as functionality of the flooring product, see FIGS. 3 and 4. Still further, as described supra, because the liquefied mixture material is sprayed, the thickness can be varied as desired or appropriate for a particular application.

FIG. 3 is an example illustration of a single-sided mold 300 in accordance with an aspect of the innovation. As described above, the mold 300 can include surface treatments, such as but not limited to, a logo 302 and/or a grain type surface 304 (e.g., ridges) applied to a top surface 306 of the mold 300. To facilitate the removal of the flooring product after application of the liquefied mixture, the single-sided mold 300 has a draft angle of approximately 90 degrees.

FIG. 4 is an example illustration of a vehicle 400 incorporating a finished flooring product 402 in accordance with an aspect of the innovation. In the illustrated example, the flooring product 402 includes surface treatments comprised of a logo 404 and ridges 406 transferred from the top surface 306 of the mold 300, shown in FIG. 3. As mentioned above, the surface treatments enhance both the aesthetics and the functionality of the flooring product 402.

As described herein, the spray mixture can be a combination of urethane (e.g., approximately 5%) and polyurea (e.g., approximately 95%). Those skilled in the art will understand that polyurea is a type of elastomer that is derived from the reaction product of an isocyanate component and a synthetic resin blend component through step-growth polymerization. In accordance with the innovation, the mixture can be sprayed into a mold (e.g., single-part mold) or directly upon a floor surface (e.g., metal, backing material). As described herein, when sprayed into a mold, it will be appreciated that, because a single-sided mold is used, shear can be alleviated as would be present in a conventional two-part molding process.

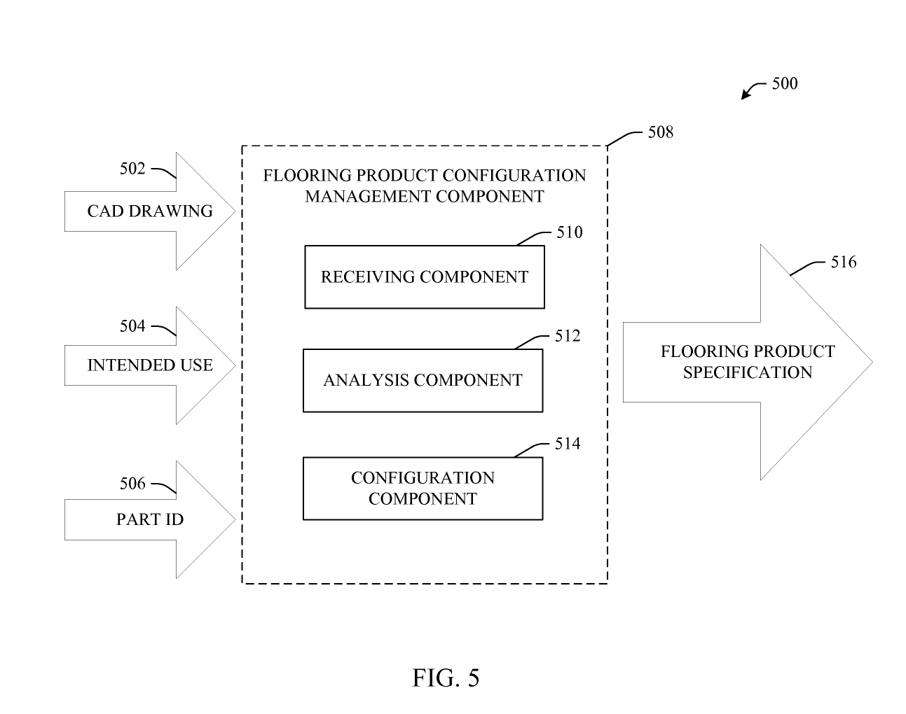

With reference to FIG. 5, it will be appreciated that the flooring product can be automatically designed using computer automation. Specifically, a flooring product specification or design may be obtained with the analysis of various parameters input into a computer system 500. For example, some but not all input parameters may include information from a CAD drawing 502, the intended use 504 of the part, part identification 506, etc. Information from the CAD drawing 502 may include dimensions, locations of holes, cutouts, bends, etc. Intended use 504 may include information such as where the part will be installed in the vehicle, orientation of the part, how the part will interface with other parts in the vehicle, etc. The part identification 506 may include a part number, part description, the weight of the part, etc.

The input parameters may be input into a flooring product configuration management component 508 of the computer system 500 where the information is processed. The flooring product configuration management component 508 may include several processing components, such as but not limited to a receiving component 510, an analysis component 512, and a configuration component 514. The receiving component 510 receives the information from the input parameters and sends the input information to the appropriate component within the flooring product configuration management component 508. The analysis component 512 analyzes the information from the input parameters to determine an optimum flooring product configuration. Finally, the configuration component 514 configures the flooring product based on the resulting information from the analysis component 512.

The information from the flooring product configuration management component 508 is output in the form of a specification. For example, the optimum flooring product configuration may be output in the form of a flooring product specification 516, which is used to fabricate the part.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle flooring system comprising:
a single-sided mold component; and
a spray application component that facilitates application of a liquefied mixture into the single-sided mold, wherein the application results in a vehicle flooring product.

2. The vehicle flooring system of claim 1, wherein the liquefied mixture is a combination of urethane and polyurea.

3. The vehicle flooring system of claim 2, wherein the liquefied mixture is approximately 5% urethane and approximately 95% polyeura.

4. The vehicle flooring system of claim 1, wherein a foil is molded-in upon application of the liquefied mixture, and wherein the foil provides heat deflection from a passenger compartment of the vehicle.

5. The vehicle flooring system of claim 1, wherein the single-sided mold component has a draft angle of approximately 90 degrees.

6. The vehicle flooring system of claim 1, wherein the single-sided mold component has a top surface having at least one surface treatment.

7. The vehicle flooring system of claim 6, wherein the at least one surface treatment is a logo and/or ridges and/or a grain structure.

8. The vehicle flooring system of claim 7, wherein the flooring product is a floor mat.

9. A method for forming a vehicle flooring product comprising:
providing a single-sided mold;
spraying a liquefied mixture into the single-sided mold;
curing the liquefied mixture for a pre-determined amount of time; and
removing the cured mixture from the single sided mold, wherein the cured mixture is the vehicle flooring product.

10. The method of claim 9, wherein prior to spraying a liquefied mixture into the single-sided mold, the method comprising combining urethane and polyeura into the liquefied mixture.

11. The method of claim 10, wherein the liquefied mixture is approximately 5% urethane and approximately 95% polyeura.

12. The method of claim 9, further comprising inserting a foil into the single-sided mold, wherein the foil is molded-in upon spraying of the liquefied mixture, and wherein the foil provides heat deflection from a passenger compartment.

13. The method of claim 9, wherein the single-sided mold has a draft angle of approximately 90 degrees.

14. The method of claim 9, wherein the single-sided mold has a top surface having at least one surface treatment.

15. The method of claim 14, wherein the at least one surface treatment is a logo and/or ridges and/or a grain structure.

16. The method of claim 15, wherein the flooring product is a floor mat.
